(19) United States
(12) Patent Application Publication
(10) Pub. No.: US 2010/0138242 A1
(43) Pub. Date: Jun. 3, 2010

(54) Electronic Vehicle Repair Management (eVRM)

(75) Inventors: David P. Ferrick, Medford, MA (US); Christina Scalcione, Medford, MA (US); Gal Steinberg, Medford, MA (US)

Correspondence Address: Sunstein Kann Murphy & Timbers LLP, 125 SUMMER STREET, BOSTON, MA, 02110-1618, US

(73) Assignee: CROSS COUNTRY AUTOMOTIVE SERVICES, Medford, MA (US)

(21) Appl. No.: 12/501,754

(22) Filed: Jul. 13, 2009

Related U.S. Application Data
(60) Provisional application No. 61/080,377, filed on Jul. 14, 2008.

(51) Int. Cl. G06Q 40/00; G01M 17/00; G06Q 10/00; G06Q 50/00

(52) U.S. Cl. 705/4; 701/33; 705/306; 705/35

(57) ABSTRACT

Automated processing of damage data related to a damaged vehicle is described. Damaged vehicle data including vehicle location data is received at a vehicle repair processor (VRP) from a user mobile device (UMD), either at the time of an accident or when a vehicle is disabled. The vehicle data may be augmented by data directly from the damaged vehicle by telematics processing. A repair decision is generated by the VRP based on the damage data which reflects whether or not to treat the damaged vehicle as likely to be commercially repairable. From the repair decision, a vehicle destination is determined by the VRP for delivery of the damaged vehicle, and the vehicle destination is communicated to the UMD.

This application claims priority from U.S. Provisional Patent Application 61/080,377, filed Jul. 14, 2008, which is incorporated herein by reference.

### FIELD OF THE INVENTION

The present invention pertains to vehicular services that leverage various communication channels to facilitate decision processes involving damaged vehicles. More particularly, the present invention pertains to making repair or total loss decisions regarding damaged vehicles and selecting appropriate destinations for the damaged vehicles based on such decisions and other location based data.

### BACKGROUND ART

Vehicles involved in accidents are typically categorized into one of two classes: repairable vehicles or total loss vehicles. “Total loss” as used in the industry does not mean that the vehicle cannot be repaired; rather it refers to the situation where the cost of repair exceeds the value of the vehicle. This decision can be based on a mathematical formula which determines if the cost to repair the damaged vehicle is greater than the actual market value for the damaged vehicle. For example, a gross estimate amount reflecting the estimated cost to repair the vehicle may be divided by the actual cash value to replace the vehicle. If the amount of the loss estimate calculation mentioned above, is greater than some threshold factor (e.g., 70-80%), then the vehicle is typically considered a total loss.

Various other factors may also be considered to determine whether or not the damaged vehicle should be classified as a total loss, such as:
Will the repairs comply with the relevant state regulations?
Will the repaired vehicle be safe to drive?
   Depending on the answers to such questions, the vehicle may also be deemed a total loss. Once the determination is made, total loss vehicles are transported to salvage auction pools, while repairable vehicles are transported to body shops for mechanical and body repair.

Initially, a total loss determination may typically be based on a verbal Total Loss Questionnaire (TLQ) between the customer and their insurance carrier via phone during the phone contact made by the policyholder to report the damage to the vehicle. Another evaluation may be conducted later by an insurance appraiser/adjuster who visually inspects the damaged vehicle. The TLQ is a series of questions asked to the policyholder to determine the condition of the vehicle in order to determine if the vehicle is likely to be a total loss. While these questions are typically asked of all policyholders, only a fraction of the total loss vehicle population is identified through this interview process. Typically the interview process does not work because at the time the policyholder is making the call to the insurance carrier, he or she no longer has access to the damaged vehicle to accurately answer the questions. Additionally, the policyholder does not otherwise have the technical skills to answer the questions asked by the insurance carrier.

Phone questionnaires at the time of the loss report are more cost effective for insurance carriers and help move the damaged vehicle through the claim process more quickly. If the insurance carrier initially determines that the damaged vehicle is a total loss, then the vehicle is automatically assigned to a salvage company who arranges for it to be moved. This avoids unnecessary tows and loss adjustment expense. Such processes help drive significant loss cost reduction on a per claim basis. Among the savings categories are:

Loss Adjustment Expense—the cost the insurance carrier incurs to actually process a claim for the damaged vehicle.

Storage Expense—Typically, damaged vehicles are moved to a storage facility that charges a per diem rate. Each day that the vehicle sits awaiting disposition increases the storage costs.

Rental—Customers that have rental coverage begin accumulating rental charges during delays in the vehicle disposition.

Miscellaneous Administrative Expenses—There are other administrative expenses that are triggered by time, such as notification fees.

Additional Towing Expense—If the damaged vehicle is moved to the incorrect facility, then there will be additional expenses to reroute the vehicle to the correct disposition point.

### SUMMARY OF THE INVENTION

Embodiments of the present invention are directed to a method for processing vehicle accident damage data. Through telematics processing, damage data can be transmitted directly from the damaged vehicle to a remote vehicle repair processor (VRP). Damage data can also be transmitted to the VRP from a user mobile device (UMD) operated by a towing service at the damaged vehicle location. A repair decision is generated by the VRP based on the received damage data, which reflects a likelihood assessment of whether the damaged vehicle is likely to be commercially repairable (repair vs. total loss). Once the likelihood assessment is made, a target destination for the damaged vehicle is determined by the VRP based on the repair decision and location based processing. The target destination of the damaged vehicle is then communicated to the UMD. Using location based technology, the proper target destination can be determined based on a multitude of factors including but not limited to the following:
Customer—preferred repair destination
Insurance carrier—preferred repair destination
Proximity of the closest available and equipped facility
Proximity of the closest available salvage provider
Location of the damaged vehicle.

In further such embodiments, the method may also include authorization of the transportation of the damaged vehicle with the VRP to the target vehicle destination. Before receiving the damage data, the VRP may also verify insurance coverage for the damaged vehicle. Generating a repair decision by the VRP may include determining a gross estimate amount which reflects the cost to repair the damaged vehicle, determining an actual cash value which reflects the cost to replace the damaged vehicle, and generating the repair decision as a function of the gross estimate amount and the actual cash value.

In some embodiments, the vehicle damage data may include at least one electronic image (e.g., digital photograph or video image) of the damaged vehicle at the damaged vehicle location. The UMD, operated by a towing service at the damaged vehicle location, may be used to create and transmit the electronic image data to the VRP which may use a single or multiple presentation interfaces for receiving the damage data.

Embodiments of the present invention also include a method for automated processing of damage data related to a damaged vehicle in which damage data is communicated from a UMD to a VRP. A vehicle destination location is received at the UMD from the VRP for delivery of the damaged vehicle based on the repair decision generated by the VRP. Automated processing of the damage data at the VRP is used to make the repair decision which is then combined with location data that is related to possible vehicle target destinations.

In further such embodiments, the damaged vehicle may be transported to the proper repair or salvage destination. The damage data may include insurance coverage data for the damaged vehicle. The repair decision may reflect a gross estimate amount to repair the damaged vehicle and an actual cash value cost to replace the damaged vehicle.

In some embodiments, the damage data may include at least one electronic image of the damaged vehicle (e.g., digital photograph or video image) at the damaged vehicle location. The UMD may be operated by a tow truck operator at the damaged vehicle location. Using location-based technology, the proper destination can be determined based on a multitude of factors including but not limited to the following:

Customer—preferred repair destination

Insurance carrier—preferred repair destination

Proximity of the closest available and equipped facility

Proximity of the closest available salvage provider

### BRIEF DESCRIPTION OF THE DRAWINGS

FIG. 1 shows various logical steps in one specific embodiment of the present invention.

FIG. 2 shows a high level communication flow for an embodiment of the present invention.

### DETAILED DESCRIPTION OF SPECIFIC EMBODIMENTS

Various embodiments of the present invention are directed to processing and handling damaged vehicles, starting from when an insurance policyholder or claimant reports a vehicle accident to their insurance carrier, including whether or not the damaged vehicle can still be driven. If the damaged vehicle is not drivable, then the insurance carrier may engage a third party service provider to process the damaged vehicle on their behalf. A tow truck is dispatched to the damaged vehicle location, and the tow truck operator operates a user mobile device (UMD) that engages one or more presentation interfaces (including but not limited to voice and/or web interfaces utilizing wired or wireless networking) for a vehicle repair processor (VRP) to answer a short list of questions. Based on the responses, the VRP automatically determines whether the damaged vehicle is likely to be commercially repairable or a total loss using a customizable processing algorithm. Based on that determination and on the claim information provided by the insurance carrier or the insurance carrier's profile information, the tow truck driver is instructed to tow the damaged vehicle either to a salvage auction pool (as a total loss) or to a body shop (for repairs). This process reduces towing fees, storage fees, loss administration fees, and other related expenses by moving the vehicle to its ultimate destination quickly.

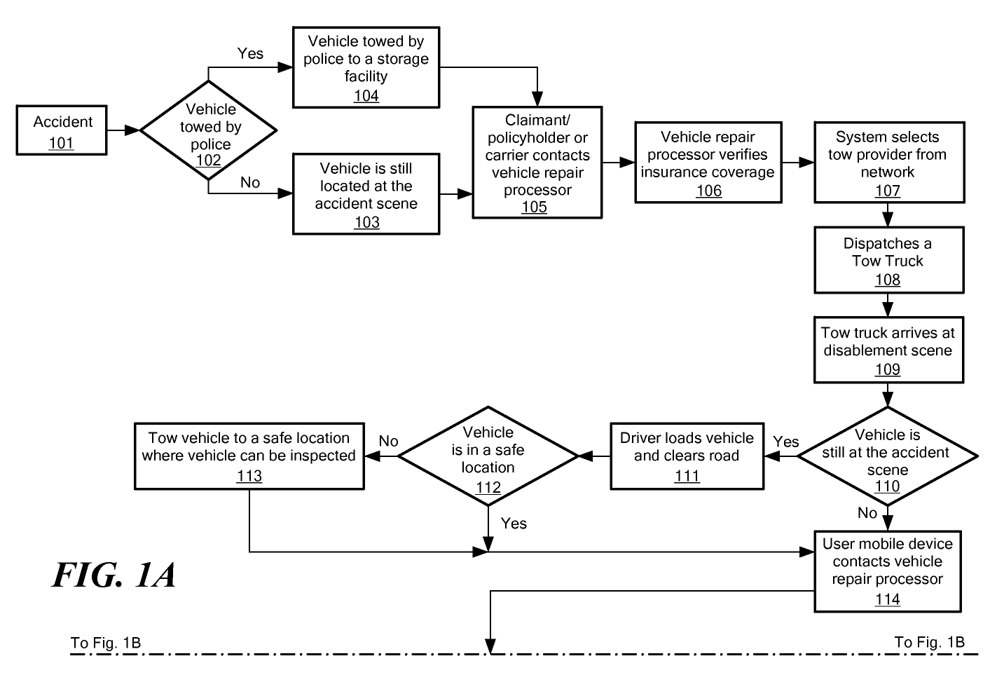

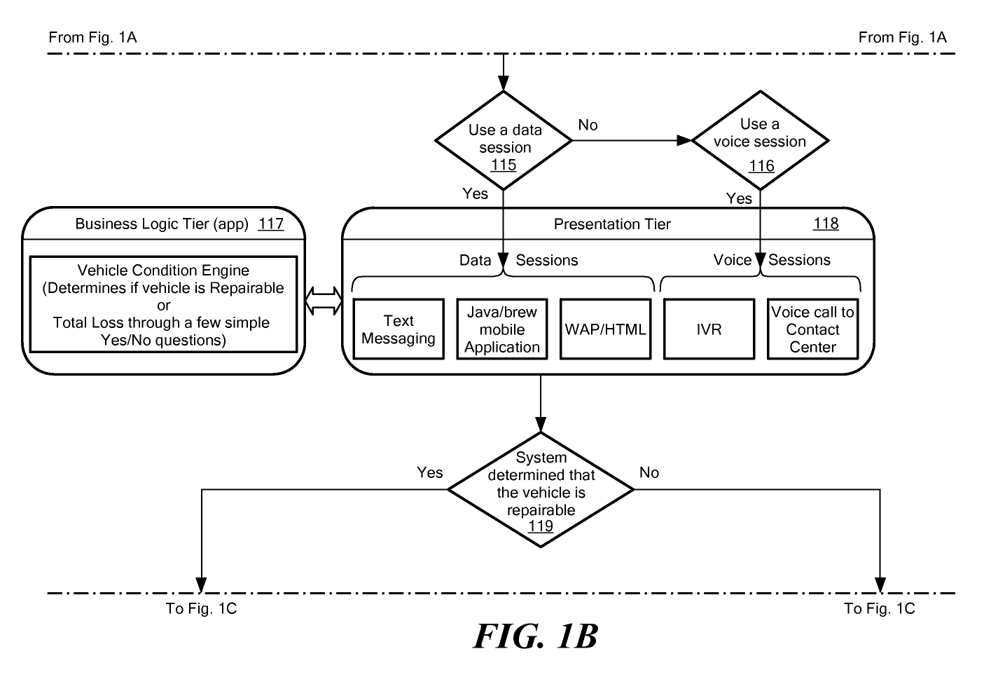

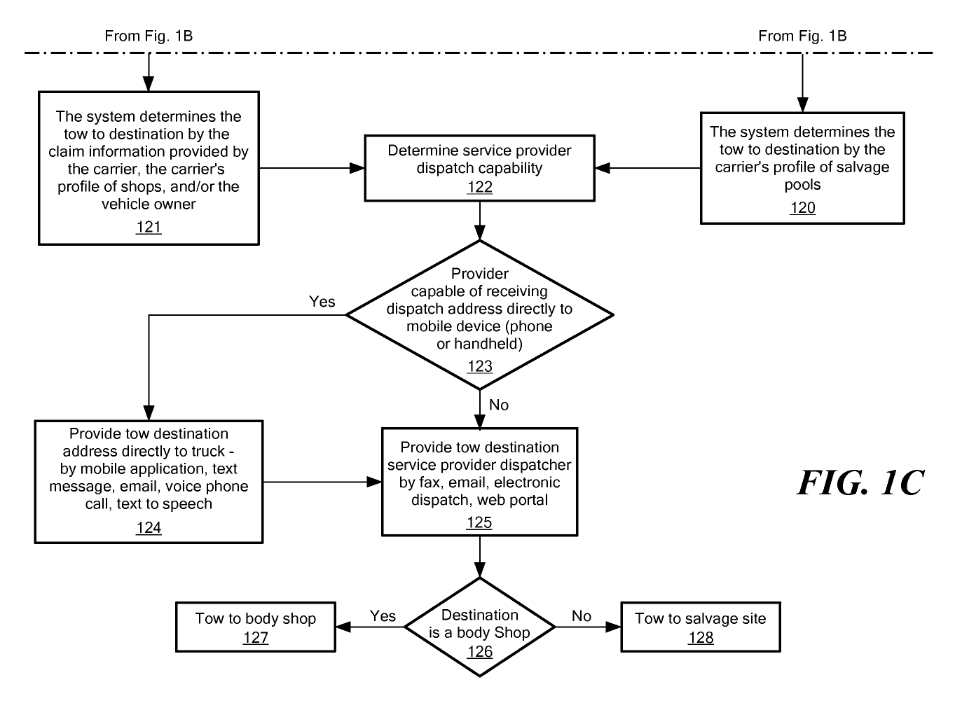

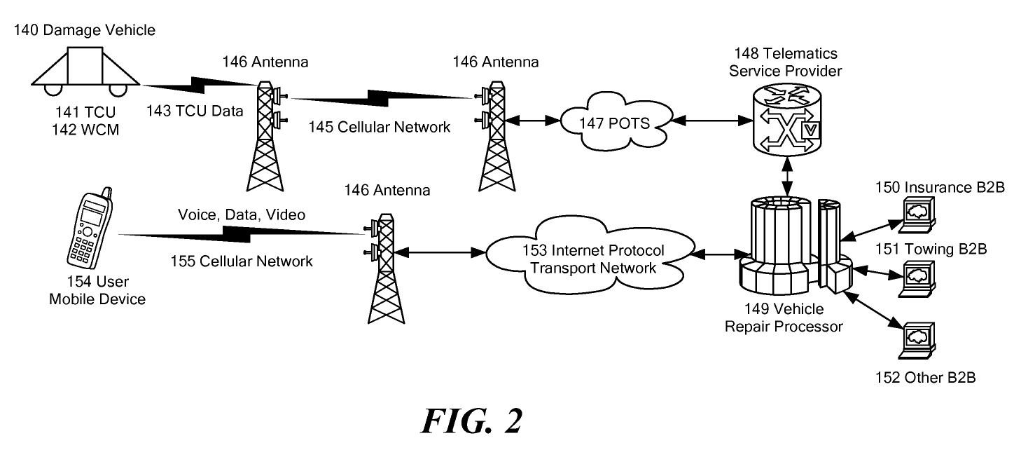

FIG. 1 illustrates various logical steps in the process flow of one specific embodiment, and FIG. 2 shows a high level communication flow for an embodiment of the present invention. After a vehicle is first damaged or disabled (usually by an accident 101), it will be located at or near the accident scene 103 (e.g., parking lot, local business, side of the road, etc) or at a temporary storage facility 104, or at the owner's residence. The policy holder or claimant reports the accident to the insurance carrier who may automatically route phone calls to a third party road VRP, or else the report may be directly to the VRP 105. The VRP or insurance carrier verifies insurance coverage 106 and selects a tow service provider 107 based on location of the damaged vehicle. In response to the damaged vehicle report, the VRP dispatches a tow truck to the vehicle location 108.

Once the tow truck driver arrives 109, if the damaged vehicle is still at the accident scene 110, the tow truck operator loads the vehicle and clears the accident scene from any debris 111 and determines if the vehicle is in a safe location for inspection 112. If needed, the tow truck driver can load the damaged vehicle and remove it from the scene before inspection 113.

Once at the vehicle location with the scene and the vehicle secure, the tow truck operator uses a user mobile device (UMD) to contact the VRP system 114, and the VRP guides the tow truck operator through a workflow on the UMD using a series of questions. Although the following discussion is phrased in terms of a tow truck driver operating a UMD, that is not necessarily the case. For example, in some embodiments, the UMD may be operated by specialized field assessor or by the vehicle driver using an interactive application on a personal mobile device. Note that the VRP can receive additional damage data that is automatically communicated by an in-vehicle telematics system.

The UMB user presentation interface may be based on a data session 115 or a voice session 116, or a combination of voice and data. That is the UMB user presentation interface can be multi-modal. The UMD user presentation interface reflects a presentation tier 118 that interfaces the tow truck operator user on the UMD with a business logic engine 117 that performs the determination algorithm. Embodiments may support multiple interfaces. For example, the presentation tier 118 may include a data session interface such as a WAP or HTML interface, a mobile application interface such as Java, Brew, Android, or others (if device is capable), and/or an active text messaging interface (by replying “Y/N”, “Yes/No”, or multiple choice) or a combination of data and voice interfaces. The presentation tier 118 may be based on clicking on an application interface that shows parts of a vehicle to determine condition (i.e. without using a form field questionnaire). For example, the application interface instructions may be:
“push this button (or #1) if the vehicle overturned, has fire damage, or has flood damage”
“push this button (or #2) if the vehicle has damage on multiple vehicle zones, if so, select which region”
   Voice communication interfaces may be based on interactive voice response (IVR) system, or a voice call to a person at a contact call center, or a combination of voice and data to an IVR system or a person at a contact call center. Some embodiments may support multiple languages so that the tow truck operator may select the language of the interface. Some embodiments may support multiple icons so that the tow truck operator may click on to indicate the response to the questions.

Specific embodiments may support multiple UMD types allowing the tow truck operator to interface with the VRP system using his/her device preference, including without limitation:

A voice-enabled cell phone

A voice- and data-enabled cell phone (including Smartphones)

A data-supporting cellular data application (e.g., GPRS, EDGE, UMTS, EV-DO)

A handheld device
Wireless capable (802.11X, WiMax)
USB

An internet-enabled device (e.g., laptop, desktop, handheld)

Some embodiments also may support uploading of electronic images such as photos and/or video images from the vehicle location. For example, such electronic images may be provided by a camera enabled cell phone or a digital camera (with Bluetooth or other means of uploading pictures or video streams to an application).

Subsequent to the UMD interaction at the damaged vehicle location, the VRP determines whether or not the damaged vehicle is likely to be commercially repairable 119 and a corresponding appropriate tow-to destination. For total loss vehicles, the VRP will determine the salvage facility based on the carrier's profile of salvage pools 120. For repairable vehicles, the system determines the body shop 121 by using the claim information, a carrier profile of body shops and their locations relative to the vehicle location, insurance carrier preference, and/or the vehicle owner preference. The vehicle repair processor then dispatches the appropriate tow truck provider 122. If data can be provided directly to the tow truck driver 123, the UMD displays the destination address and facility name to the tow truck driver 124 using one or more of:

The Driver's cell phone or handheld device using a text message and/or email (Data)

Driver's cell phone or handheld device using the mobile application (Java etc . . . ) (Data)

Driver's cell phone or handheld device using text to speech (Voice)

Driver's cell phone or handheld device using a live agent (Voice)

In addition to the above, the vehicle repair processor may use fax/email/voice or electronic dispatch (e.g., via a Web Services interface or similar business to business (B2B) electronic transaction) to notify the tow truck provider dispatch center 125; for example, by the tow truck provider's website or web portal. Based on this process, the damaged vehicle is then towed to the determined destination. If the destination is a body shop 126, the vehicle is towed there for repairs 127, or otherwise, it is towed to the salvage site as a total loss 128.

Embodiments of the present invention leverage various communication channels to facilitate decision processes involving damaged vehicles. FIG. 2 shows the communication flow for an embodiment that includes crash data detected by a telematics control unit (TCU) 141 that is embedded within the damaged vehicle. Examples of such telematics crash data 143 include without limitation: impact sensor information, vehicle orientation, airbag status, speed at impact, geographical information, and passenger restraint status. The TCU 141 detects crash data 143 that can be communicated via a wireless communication module (WCM) 142, also embedded within the vehicle, over a cellular network 145 to a telematics service provider TSP 148 data center. The VRP 149 can receive and utilize the TCU crash data 143 to augment the data provided by the UMD 154. The UMD 154 can connect to the VRP via cellular network 155 and internet communication channel 153 capable of transmitting voice, data, and video. The UMD 154 can also connect directly to the TSP 148 data center and then pass TCU crash data 143 to the VRP 149. The VRP 149 is capable of connecting to a variety of business-to-business (B2B) information sources including insurance 150, towing 151, and others sources 152. One benefit of leveraging various communication channels is to make a quick and well informed decision regarding an optimal destination for a damaged vehicle.

Embodiments of the invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented in whole or in part as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method for automated processing of vehicle damage data related to a damaged vehicle, the method comprising:
receiving damage data at a vehicle repair processor (VRP) from a user mobile device (UMD) at a damaged vehicle location;
generating a repair decision with the VRP from the damage data, the repair decision reflecting a likelihood assessment of whether the damaged vehicle is likely to be commercially repairable; and
determining a destination for the damaged vehicle based on the repair decision.

2. A method according to claim 1, further comprising:
authorizing with the VRP transportation of the damaged vehicle to the vehicle destination.

3. A method according to claim 1, wherein prior to receiving the damage data, the VRP verifies insurance coverage for the damaged vehicle.

4. A method according to claim 1, wherein the damage data further includes data directly from the damaged vehicle using telematics processing.

5. A method according to claim 1, wherein generating a repair decision includes:
determining a gross estimate amount reflecting a likely cost to repair the damaged vehicle;
determining an actual cash value of the damaged vehicle; and
generating the repair decision as a function of the gross estimate amount and the actual cash value.

6. A method according to claim 1, wherein the damage data includes at least one electronic image of the damaged vehicle at the damaged vehicle location.

7. A method according to claim 1, wherein the UMD is operated by a tow truck operator at the damaged vehicle location.

8. A method according to claim 1, wherein the VRP uses an interactive voice response (IVR) system for receiving the damage data.

9. A method according to claim 1, further comprising:
communicating the vehicle destination for the damaged vehicle to the UMD.

10. A method according to claim 1, wherein determining the vehicle destination is in part based on an insurance carrier preferred repair destination or an insurance customer preferred repair location.

11. A method according to claim 1, wherein determining the vehicle destination is in part based on proximity of a repair facility or salvage provider.

12. A method for automated processing of damage data related to a damaged vehicle, the method comprising:
communicating damage data from a user mobile device (UMD) at a damaged vehicle location to a vehicle repair processor (VRP); and
receiving a vehicle destination at the UMD from the VRP for delivery of the damaged vehicle based on a repair decision generated by the VRP from the damage data reflecting a likelihood assessment of whether the damaged vehicle is likely to be commercially repairable.

13. A method according to claim 12, further comprising:
arranging to transport the damaged vehicle to the vehicle destination.

14. A method according to claim 12, wherein the damage data includes insurance coverage data for the damaged vehicle.

15. A method according to claim 12, wherein the damage data further includes data directly from the damaged vehicle using telematics processing.

16. A method according to claim 12, wherein the repair decision reflects a determination by the VRP of a gross estimate amount to likely repair the damaged vehicle and an actual cash value cost to replace the damaged vehicle.

17. A method according to claim 12, wherein the damage data includes at least one electronic image of the damaged vehicle at the damaged vehicle location.

18. A method according to claim 12, wherein the UMD is operated by a tow truck operator at the damaged vehicle location.

19. A method according to claim 12, wherein the UMD uses one or more presentation interfaces for communicating with the VRP.

20. A method according to claim 12, wherein the vehicle destination is in part based on an insurance carrier preferred repair destination or an insurance customer preferred repair location.

21. A method according to claim 12, wherein the vehicle destination is in part based on proximity of a repair facility or salvage provider.

22. An automated system for processing of damage data related to a damaged vehicle, the system comprising:
a vehicle repair processing (VRP) system including an automated dialog system for processing the damage data related to the damaged vehicle;
a user mobile device (UMD) for interfacing a remote user at the location of the damaged vehicle with the VRP based on one or more presentation interfaces;
wherein the VRP:
i. obtains the damaged vehicle data from the user via the UMD;
ii. communicates a repair decision from the VRP system to the UMD based on the damage data and reflecting a likelihood assessment of whether the damaged vehicle is likely to be commercially repairable; and
iii. communicates to the UMD a vehicle destination for delivery of the damaged vehicle.

23. An automated system according to claim 22, wherein the VRP system further authorizes transportation of the damaged vehicle to the vehicle destination.

24. An automated system according to claim 22, wherein the VRP system verifies insurance coverage for the damaged vehicle prior to obtaining the damaged vehicle data.

25. An automated system according to claim 22, wherein the damage data further includes data directly from the damaged vehicle using telematics processing.

26. An automated system according to claim 22, wherein the VRP system generates a repair decision which includes:
determining a gross estimate amount reflecting a likely cost to repair the damaged vehicle;
determining an actual cash value of the damaged vehicle; and
generating the repair decision as a function of the gross estimate amount and the actual cash value.

27. An automated system according to claim 22, wherein the damage data includes at least one electronic image of the damaged vehicle at the damaged vehicle location.

28. An automated system according to claim 27, wherein the damage data includes a stream of electronic images of the damaged vehicle at the damaged vehicle location.

29. An automated system according to claim 22, wherein the UMD is operated by a tow truck operator at the damaged vehicle location.

30. An automated system according to claim 22, wherein the vehicle destination is in part based on an insurance carrier preferred repair destination or an insurance customer preferred repair location.

31. An automated system according to claim 22, wherein the vehicle destination is in part based on proximity of a repair facility or salvage provider.

32. A computer program product in a computer readable storage medium for automated processing by a computer of damage data related to a damaged vehicle, the product comprising:
program code for receiving damage data at a vehicle repair processor (VRP) from a user mobile device (UMD) at a damaged vehicle location;
program code for generating a repair decision with the VRP from the damage data, the repair decision reflecting a likelihood assessment of whether the damaged vehicle is likely to be commercially repairable; and
program code for determining a vehicle destination based on the repair decision.

33. A computer program product according to claim 32, further comprising:
program code for authorizing transportation of the damaged vehicle to the vehicle destination.

34. A computer program product according to claim 32, further comprising:
program code for verifying insurance coverage for the damaged vehicle.

35. A computer program product according to claim 32, wherein the damage data further includes data directly from the damaged vehicle using telematics processing.

36. A computer program product according to claim 32, wherein the program code for generating a repair decision includes:
program code for determining a gross estimate amount reflecting a likely cost to repair the damaged vehicle;
program code for determining an actual cash value of the damaged vehicle; and
program code for generating the repair decision as a function of the gross estimate amount and the actual cash value.

37. A computer program product according to claim 32, wherein the damage data includes at least one electronic image of the damaged vehicle at the damaged vehicle location.

38. A computer program product according to claim 32, wherein the UMD is operated by a tow truck operator at the damaged vehicle location.

39. A computer program product according to claim 32, wherein the VRP uses one or more presentation interfaces for receiving the damage data from the UMD.

40. A computer program product according to claim 32, further comprising:
program code for communicating to the UMD the destination for the damaged vehicle.

41. A computer program product according to claim 32, wherein the vehicle destination is in part based on an insurance carrier preferred repair destination or an insurance customer preferred repair location.

42. A computer program product according to claim 32, wherein the vehicle destination is in part based on proximity of a repair facility or salvage provider.
